(19) United States
(12) Patent Application Publication
(10) Pub. No.: US 2016/0136641 A1
(43) Pub. Date: May 19, 2016

(54) SPECIMEN COLLECTION DEVICE WITH RFID CAP AND MEANS FOR LOCKING INTO A TEST BLOCK

(71) Applicant: Laboratory Corporation of America Holdings, Burlington, NC (US)

(72) Inventor: Jangbir Sangha, Overland Park, KS (US)

(21) Appl. No.: 14/946,376

(22) Filed: Nov. 19, 2015

Related U.S. Application Data
(60) Provisional application No. 62/081,772, filed on Nov. 19, 2014.

(51) Int. Cl. B01L 3/00; G01N 1/10; B01L 9/06

(52) U.S. Cl. CPC B01L 3/50825; B01L 9/06; G01N 1/10; B01L 2300/0832; B01L 2300/042; B01L 2300/0609; G01N 2001/028

(57) ABSTRACT

A specimen collection device capable of maintaining chain of custody and automated specimen manipulation is provided. The specimen collection device of the present invention maintains secure association with a specimen and specimen identifying information, and provides compatibility with automated specimen handling and analysis equipment capable of transferring and/or extracting a collected specimen from clinical or environmental samples without human intervention.

### CROSS-REFERENCE TO RELATED APPLICATION

This application relates to and claims the priority of U.S. Provisional Application Ser. No. 62/081,772, which was filed on Nov. 19, 2014 and is incorporated herein by reference in its entirety.

### FIELD OF THE INVENTION

The present disclosure relates to a specimen collection device capable of automated specimen manipulation and of maintaining chain of custody of a specimen collected thereon. The device is securely associated with the specimen collection absorbent and subject identifying information to preserve chain of custody. The device is also compatible with automated specimen handling and analysis equipment and allows for transferring and/or extracting a specimen collected on the specimen collection absorbent from clinical or environmental samples without human intervention.

### BACKGROUND OF THE INVENTION

Increasingly in law enforcement it is necessary to collect biological samples as evidence of a crime or for use as identifying information of a particular human as is the case of DNA collection from suspects. In the collection of biological specimens, it is necessary to associate information about the subject with the specimen and the subject associated with the specimen at the time of collection as there is no manner for identifying a biological specimen by simple inspection. Therefore, a useful form of evidence collection device for use with biological specimens will contain, at least, a means for specimen identification. Such specimen identification means may further comprise suspect information portion for recording subject information data thereon.

The use of biological specimens as evidence further requires that the biological specimen be securely associated with the identifying information so as to assure that after collection of the specimen, the collection paper or absorbent cannot be intentionally or inadvertently switched to a different collection paper. At a minimum, a proper evidence collection device or holder should easily and clearly show that tampering was attempted either by damage to delicate indicia on the device or by overt damage to a strongly secured device.

The foregoing issues relate, generally, to a process referred to as evidence “chain of custody.” “Chain of custody” encompasses the procedures and documentation used to maintain and demonstrate the chronological history of the evidence. In biological samples, the principles of evidence or sample identification involved in maintaining proper “chain of custody” are especially critical as a fluid or cellular biological sample, once collected onto an absorbent presents no distinguishing characteristics. This lack of visual characteristics foils any attempt to properly identify such a biological fluid or cellular sample once it has become separated from its identifying information.

Another problem or issue presented in the analysis of biological specimens is the need to extract or transfer the collected sample from the original collection absorbent and onto an alternate medium to permit analysis or testing of the specimen using the analysis equipment that is available in the selected laboratory. Using existing systems and methods, human intervention is necessary to extract or transfer the collected sample from the original collection absorbent. Manual transfer or extraction of the collected specimen from the original collection absorbent introduces the possibility of sample contamination as well as operator exposure to sample, reagents, and process waste. In addition, it is often necessary to separate the collection absorbent from its originally obtained identifying information that is directly associated with the original collection absorbent for further sample processing. This separation of specimen from identifying information can lead to mistakes in associating the specimen with the correct subject or suspect or can lead to the “chain of custody” being open to question in court and a failure of proof of a crime. Sample misidentification is a major source of error both in laboratory analysis and in substantiating criminal evidence.

Accordingly, a need exists for a specimen collection device that is securely associated with the specimen collection absorbent and specimen identifying information, while providing compatibility with automated specimen handling and analysis equipment capable of transferring and/or extracting a collected specimen from clinical or environmental samples (or from environmental samples collected manually) without human intervention. Further, it would be beneficial if such device was tamper proof or tamper evident.

### SUMMARY OF THE INVENTION

A specimen collection device capable of maintaining chain of custody and automated specimen manipulation is provided. The instant specimen collection device maintains secure association with the specimen and specimen identifying information, and provides compatibility with automated specimen handling and analysis equipment capable of transferring and/or extracting a collected specimen from clinical or environmental samples without human intervention.

In some embodiments, the specimen collection device comprises a collector holder tube for insertion into a receiver void of a test block, and a specimen collector for insertion within the collector tube holder. The specimen collector comprises a closure having an insert portion and a cap portion, and a shaft having a first end coupled to the insert portion of the closure and extending therefrom. The shaft terminates at a second end that has a collection swab coupled thereto. A co-axial tube contains at least a portion of the shaft. The co-axial tube may be coupled to the insert portion of the closure at one end. In some embodiments, the specimen collector additionally comprises a chamber within the cap portion of the closure configured to hold identification indicia known in the art, such as a bar code, radio-frequency identification (RFID) tags and the like, in order to maintain the chain of custody of a collected specimen.

In some embodiments, the specimen collector device may also comprise a locking feature so that once the specimen collector is fixed within the holder tube by insertion of the closure, it is locked therein and the holder with specimen collector attached cannot be tampered with or opened without the damage being evident. At least one locking flange extends from the base of the cap portion and is configured to engage a locking receiver of the test block.

Various objects and advantages of this device will become apparent from the following description taken in conjunction with the accompanying drawings wherein, by way of illustration, certain embodiments of this disclosure are set forth.

### BRIEF DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a cross-sectional front view of a first embodiment of a specimen collection device 16 inserted into a receiver void 12 of a test block 10, the specimen collection device 16 having a closure 18 which comprises a chamber 42 in the cap portion 30 for securing an RFID tag 44.

FIG. 2 is a cross-sectional front view of an alternative embodiment of the specimen collection device 16 depicting a closure 18 having a solid cap portion 50.

FIG. 3 side perspective view of the closure 18 for the specimen collection device having the lid removed to depict the inner chamber 42 positioned within the cap portion to house an RFID tag, as well as locking flanges 54 for securement of the device to a test block.

FIG. 4 is a top perspective view of an embodiment of the test block depicting a sliding lock engagement track 56 for attachment to the closure of the specimen collection device.

FIG. 5 is a top perspective view of the lid 46 for use with an embodiment of the specimen collection device 16.

FIG. 6 is a cross-sectional perspective view of the collector holder tube 14.

### DETAILED DESCRIPTION

The purpose of the present invention is to meet collection requirements that allow blood specimen collection or body fluid collection or DNA collection to qualify for secure evidence handling and for chain of custody proof requirements in law enforcement. In particular, the present invention is directed to a specimen collector device that maintains secure association with the specimen or sample and avoids the need for any transfer of the specimen or require the transfer of a bar code or other identifying material from the specimen collector onto the sample device holder.

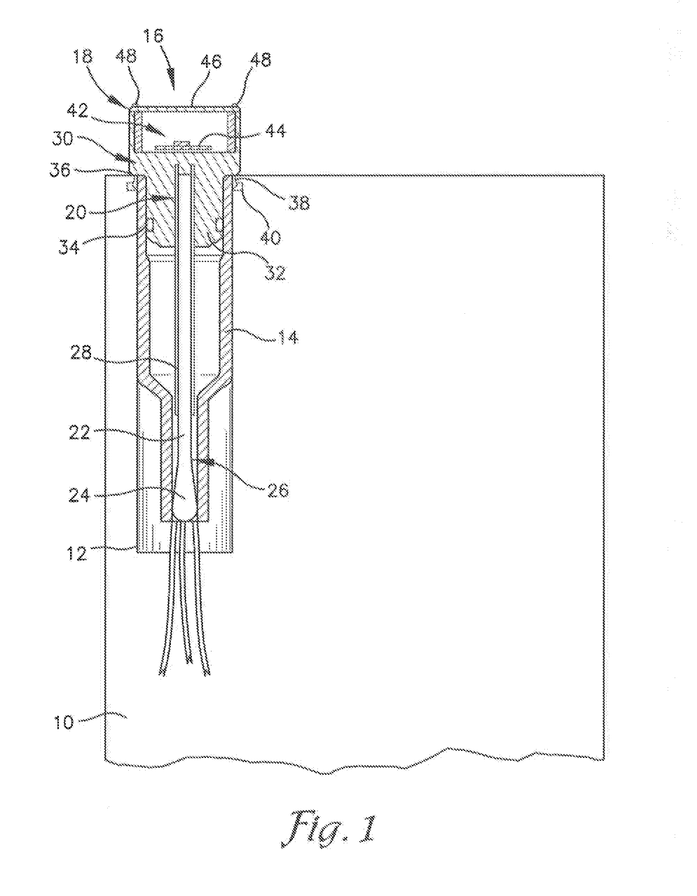

Referring now to FIG. 1, a first embodiment of a specimen collection device 16 is shown. FIG. 1 illustrates a cross-sectional view of the specimen collection device 16 inserted into a receiver void 12 of a test block 10, the specimen collection device comprising a specimen collector 22 and a collector holder tube 14, the specimen collector depicted as being inserted into the collector holder tube. The specimen collector 22 is comprised of a closure 18 having a shaft 28 connected thereto and the shaft extending from one end of the closure having a collection swab 24 attached to a second end 26 of the shaft. A co-axial tube 20 is positioned around the shaft 28.

In the embodiment of FIG. 1, the closure 18 is comprised of a cap portion 30 and an insert portion 32 for insertion of the specimen collector 22 into the collector holder tube 14. The insert portion 32 is provided with a gasket, such as an O-ring 34 so that it is sufficiently spaced from the open end 36 of the collector holder tube 14 to prevent the closure 18 from pivoting within the collector holder tube 14. By biasing the closure 18 towards a non-pivoted alignment, the O-ring 34 keeps the swab 24 from being forced against either side of the collector holder tube 14. The closure 18 is further provided with the cap portion 30 in order to seal the open end 36 of the collector holder tube 14. The cap portion 30 is sufficiently wide to permit the cap portion to contact the test block so that locking flanges 38 extending from the cap portion 36 may be inserted into lock receivers 40 located within the test block 10. The purpose of the locking flanges and the lock receivers is to allow the closure 18 to secure the specimen collection device 16 to the test block 10 so that, as internal pressure is developed within the collector holder tube, that pressure does not expel the closure from the device.

The closure 18 of the embodiment of FIG. 1 also is provided with a void or chamber 42 within the cap portion 30. Identifying information, such as a radio frequency identification chip or tag 44 (RFID), may be inserted into the chamber within the cap portion 30 and enclosed therein by the attachment of a lid 46 onto the cap portion 30. The RFID tag or chip could be a passive or active chip and would have a unique identification number associated therewith to provide a unique identifier to each individual specimen collector. It is preferred that the lid 46 be securely attached to the cap portion 30 such that only by the use destructive measures could the lid be removed. This secure attachment is intended to prevent unobserved tampering with the RFID tag 44 housed inside the cap portion. In the embodiment of FIG. 1 a sonic weld 48 may be used to attach the lid 46 to the cap portion 30. In some embodiments, the cap portion 30 is configured as a handle, but without being solid therein.

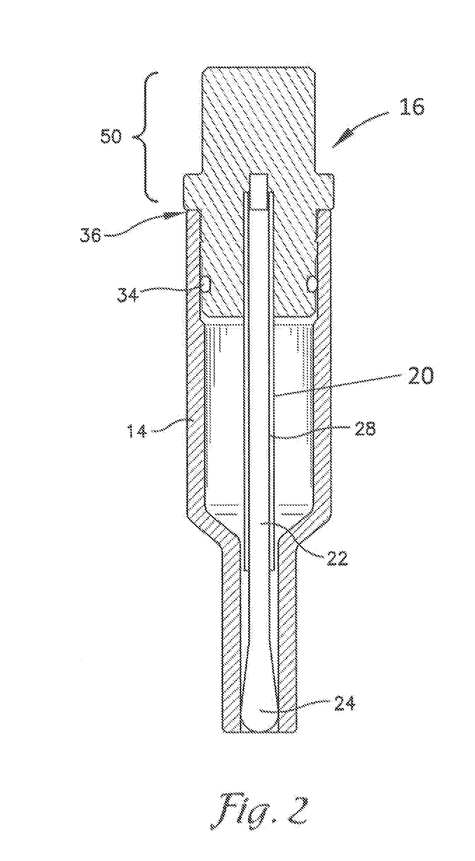

Referring now to FIG. 2, an alternative embodiment of the specimen collection device 16 is presented. Specifically, FIG. 2 depicts the closure of the device having a solid cap portion 50 rather than a void or chamber for holding identifying information, such as an RFID tag. The solid cap portion 50 is inserted into the open end 36 of the collector holder tube 14 such that the it operates as an handle for the specimen collector 22 extending from the end of the insert portion 30 of the closure. It may be seen in FIG. 2 that the O-ring 34 is positioned on the insert portion 30 and that the co-axial tube 20 surrounds the shaft 28 of the specimen collector 22.

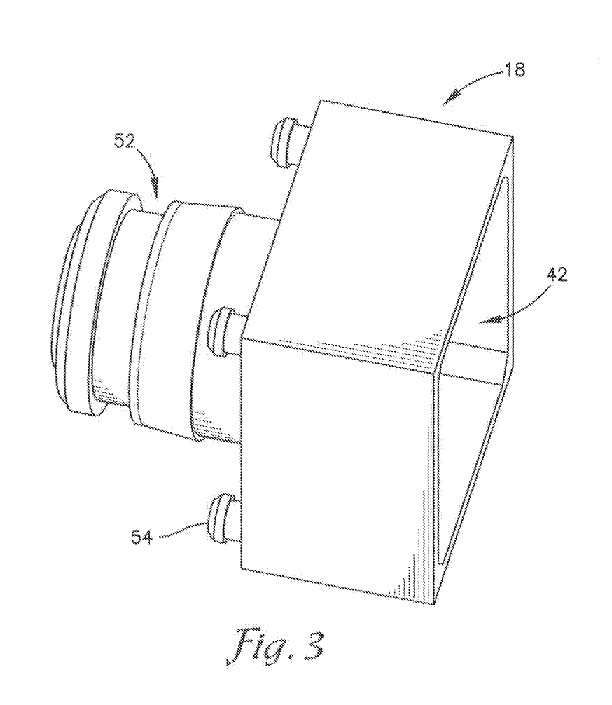

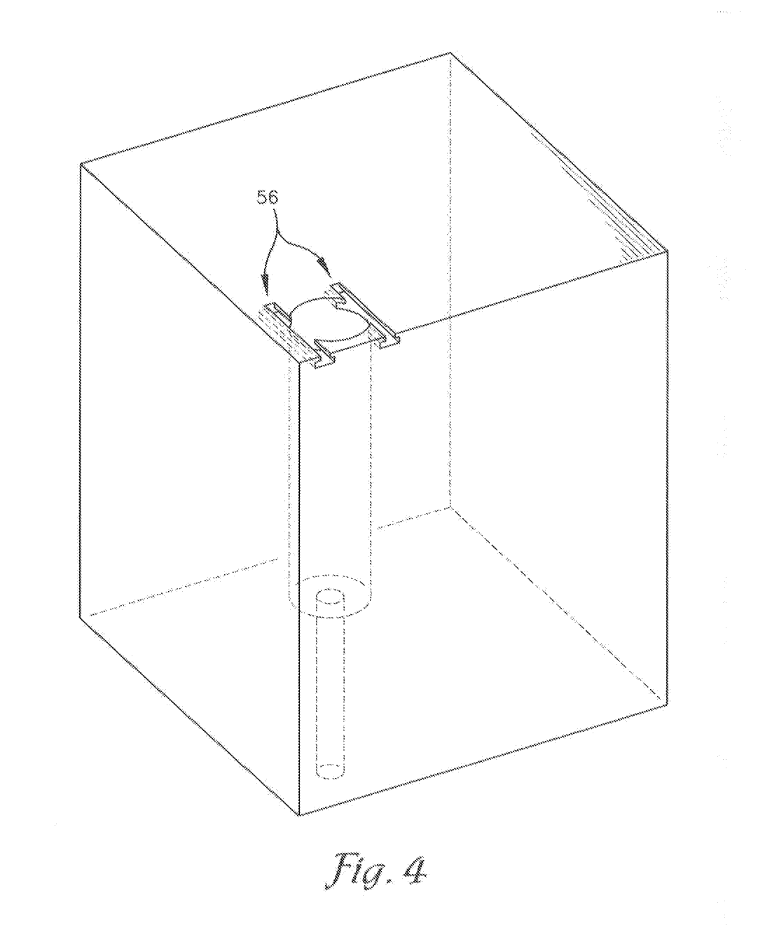

Referring now to FIG. 3, the closure 18 of FIG. 1 is shown with the lid 46 having been removed to illustrate the chamber 42 in which the RFID tag may be housed. The O-ring has been removed and the groove 52 into which the O-ring is fitted is shown. Also in FIG. 3, an embodiment of a locking flange 54 is shown that may be fitted into a sliding track mechanism 56 of a test block 10, as is shown in FIG. 4. It will be appreciated that the sliding lock engagement track 56 of FIG. 4 can provide either a releasable lock or a non-releasable lock with respect to the attachment of the closure to the test block.

Referring again to FIG. 1 and FIG. 3, the locking flanges 54 of the embodiment of FIG. 3 are shown to extend downwardly from the cap portion 30 of the closure so that they may engage with a lock receiver 40 on the test block 10, as shown in FIG. 1. The lock receiver 40 of FIG. 1 may be a void in which the flange of FIG. 3 is captured by frictional fit or the lock receiver 40 may be of a mechanical engagement type as is shown in FIG. 4.

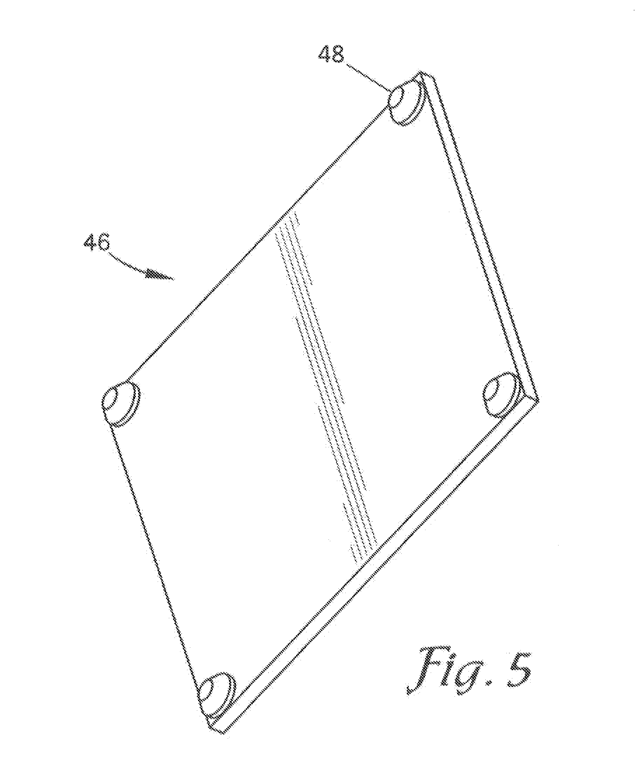

Referring now to FIG. 5, the lid 46 for attachment to the cap portion 30 illustrated in FIG. 1 is shown. The lid 46 sealingly engages the cap portion adjacent the chamber. The seal may be reversible or permanent and may be by any means known in the art, including adhesive, sonic weld 48, or mechanical means, such as a locking flange and lock receiver coupling. In a preferred embodiment, the lid is permanently sealed to the cap portion 30 in order to prevent unauthorized access to or tampering with the RFID tag 44 housed within the chamber 42 of the cap portion.

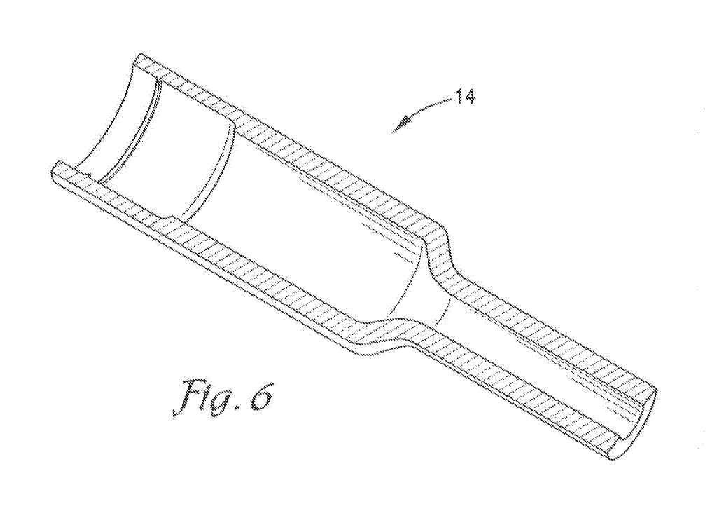

FIG. 6 shows a cross-sectional view of the collector holder tube 14 of the specimen collection device. It will be appreciated that the narrow channel wherein the collector swab 24 is disposed (as is shown in FIG. 1) is provided to limit the area in which reagents are able to flow as the reagents are injected into the test block and forced upwardly into the collector swab to dissolve any biological specimen that is on the swab. It will be appreciated that when the collector holder tube 14 is being used apart from the test block 10 that a bottom end cover or cap may be provided to close the narrow end of the collector holder tube 14 near the swab to avoid contamination of the swab and any specimen collected thereon.

One skilled in the art would readily appreciate that the devices described herein are representative of exemplary embodiments, and not intended as limitations on the scope of the disclosure. It will be readily apparent to one skilled in the art that varying substitutions and modifications may be made to the present disclosure disclosed herein without departing from the scope and spirit of the disclosure. The present disclosure illustratively described herein suitably may be practiced in the absence of any element or elements, limitation or limitations that are not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the present disclosure claimed. Thus, it should be understood that although the present disclosure has been specifically disclosed by preferred embodiments and optional features, modification and variation of the concepts herein disclosed may be resorted to by those skilled in the art, and that such modifications and variations are considered to be within the scope of this disclosure as defined by the appended claims.

What is claimed is:

1. A specimen collection device comprising:
a collector holder tube for insertion into a receiver void of a test block; and
a specimen collector for insertion within the collector holder tube, the specimen collector comprising:
a closure having an insert portion and a cap portion,
an O-ring positioned on the insert portion such that the closure is biased towards a non-pivoted alignment when inserted within the collector holder tube;
a shaft having a first end coupled to the insert portion and extending therefrom, the shaft terminating at a second end that has a collection swab coupled thereto,
a chamber within the closure configured to hold a radio frequency identification tag therein, and
at least one locking flange extending from the cap portion and configured to engage a locking receiver of the test block.

2. The specimen collection device of claim 1, wherein the locking receiver comprises a sliding lock engagement track.

3. The specimen collection device of claim 1, wherein the locking receiver comprises a void configured to secure the at least one locking flange via a frictional fit.

4. The specimen collection device of claim 1, wherein the insert portion of the specimen collector comprises a groove for seating the O-ring.

5. The specimen collection device of claim 1, wherein the specimen collector further comprises a lid configured to sealingly engage the cap portion adjacent the chamber.

6. The specimen collection device of claim 5, wherein a seal of the lid is reversible.

7. The specimen collection device of claim 5, wherein the seal of the lid is permanent.

8. The specimen collection device of claim 1, wherein the specimen collector further comprises a co-axial tube containing at least a portion of the shaft.

9. The specimen collection device of claim 1, wherein the collector holder tube comprises a narrow channel positioned such that, when the specimen collector is inserted in the collector holder tube, the collection swab is contained within the narrow channel.

10. A specimen collection device comprising:
a collector holder tube for insertion within a receiver void of a test block; and
a specimen collector for insertion within the collector holder tube, the specimen collector comprising:
a closure having an insert portion and a cap portion configured as a handle,
an O-ring positioned on the insert portion such that the closure is biased towards a non-pivoted alignment when inserted within the collector holder tube;
a shaft having a first end coupled to the insert portion and extending therefrom, the shaft terminating at a second end that has a collection swab coupled thereto,
at least one locking flange extending from the cap portion and configured to engage a locking receiver of the test block.

11. The specimen collection device of claim 10, wherein the cap portion is solid.
